(19) United States
(12) Patent Application Publication
(10) Pub. No.: US 2011/0290833 A1
(43) Pub. Date: Dec. 1, 2011

(54) Hand Tool Cord Tether and Method

(76) Inventor: Rosalie Rachel Koerner, Orem, UT (US)

(21) Appl. No.: 12/790,990

(22) Filed: Jun. 1, 2010

(51) Int. Cl. A45F 5/00; B25B 29/00

(52) U.S. Cl. 224/222; 224/250

(57) ABSTRACT

A hand tool cord tether device includes an arm coupler attachable to an arm of a user of the hand tool. A cord coupler is attachable to a cord of the hand tool. The arm coupler is removably coupleable to the cord coupler in order to retain the cord along the user's arm

### BACKGROUND OF THE INVENTION

1. Field of the Invention

The present invention relates generally to hand tools, such as dental hand tools, micro sanders, micro grinders, and the like. More specifically, the present invention relates to hand tools that have utility cords, such as pneumatic lines, suction lines, power lines, and the like.

2. Related Art

Hand tools are devices that can be held, and generally operated, in a single hand of a user. Examples of hand tools include dental hand tools, handheld micro grinders and sanders, handheld vibropeening tools, and the like.

While some hand tools are cordless and are powered by batteries, many others have at least one utility cord, line or cable. Some hand tools, such as dental hand tools, can have multiple utility lines such as electrical lines, pneumatic lines, water lines, suction lines, and the like. Unfortunately, these utility lines can interfere with operation of the hand tool by either dragging into the workspace or by creating a tugging or pulling force on the hand tool during operation.

For example, in the case of dental hand tools, the utility cords can extend from an instrument table having utility outlets to the hand tool. When such tools are held by a dental worker and moved to the patient's mouth, the utility lines can become tangled in nearby equipment and in some cases may drape across the patients face. Additionally, the weight or automatic retraction of the cord can create a tugging or pulling force on the hand tool at inconvenient times during a tooth repair which might cause the dental professional to over correct with an opposite force and possibly damage the tooth being worked on. Moreover, the weight and tugging forces from the cords can induce fatigue in the dental worker's hands which may compromise the techniques in use at any given time. Such interference can make operation of the tool difficult for the dental worker, and can cause irritation or annoyance to the patient.

### SUMMARY OF THE INVENTION

The inventor of the present invention has recognized that it would be advantageous to develop a tethering system for tethering and festooning the utility cord or cords of hand held tool in order to keep the cord out of the way of the work space and to reduce drag or tugging forces on the hand tool from the cord.

The invention provides a hand tool cord tether device having an arm coupler attachable to an arm of a user of the hand tool. A cord coupler can be attachable to a cord of the hand tool. The arm coupler can be removably coupleable to the cord coupler in order to retain the cord along the user's arm when the user is holding the hand tool.

In accordance with another aspect of the present invention an arm attachment portion can be attached to an arm of a user of the hand tool and a cord attachment portion can be attached to a cord of the hand tool. The arm attachment portion and the cord attachment portion can carry the arm coupler and the cord coupler respectively and facilitate coupling of the cord to the user's arm.

The present invention also provides for a method for using a hand tool including tethering a cord of the hand tool to an arm of a user of the hand tool in order to reduce drag or pull of the cord of the hand tool on the user. The hand tool can be operated with the cord tethered to the user's arm.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a perspective view of a hand tool cord tether device in accordance with an embodiment of the present invention, shown in a separated configuration;

FIG. 2 is a perspective view of the hand tool cord tether device of FIG. 1, shown in a coupled configuration;

FIG. 3 is a perspective view of the hand tool cord tether device of FIG. 1, shown in a separated configuration and deployed on a user's arm and a hand tool cord;

FIG. 4 is a perspective view of the hand tool cord tether device of FIG. 1, shown in a coupled configuration and deployed on the user's arm and the hand tool cord;

FIG. 5 is a perspective view of a hand tool cord tether device in accordance with another embodiment of the present invention;

FIG. 6 is a perspective view of a hand tool cord tether device in accordance with another embodiment of the present invention;

FIG. 7 is a perspective view of a hand tool cord tether device in accordance with another embodiment of the present invention;

FIG. 8 is a perspective view of a hand tool cord tether device in accordance with another embodiment of the present invention;

FIG. 9 is a perspective view of a hand tool cord tether device in accordance with another embodiment of the present invention;

FIG. 10 is a perspective view of a hand tool cord tether device in accordance with another embodiment of the present invention; and

FIG. 11 is a perspective view of a hand tool cord tether device in accordance with another embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The embodiments of the present invention described herein provide generally for a tethering device for tethering a utility cord of a powered hand tool, such as dental hand tools, handheld micro grinders and sanders, handheld vibropeening tools, and the like. The tethering device can include an arm piece and a cord piece. The arm piece can be coupled to an arm of a user of the hand tool and can include an arm coupler. The cord piece can be coupled to a utility cord of the hand tool and can include a cord coupler. The arm coupler and the cord coupler can be coupled together in order to tether the cord to the arm of the user of the hand tool. In one embodiment, the arm coupler can include one of a magnet and a magnetically attractable material, and the cord coupler can include the other of the magnet and magnetically attractable material. In this embodiment the arm coupler can be magnetically attracted to the cord coupler such that the cord coupler can be easily coupled or uncoupled to the arm coupler in order to tether the cord to the arm of the user.

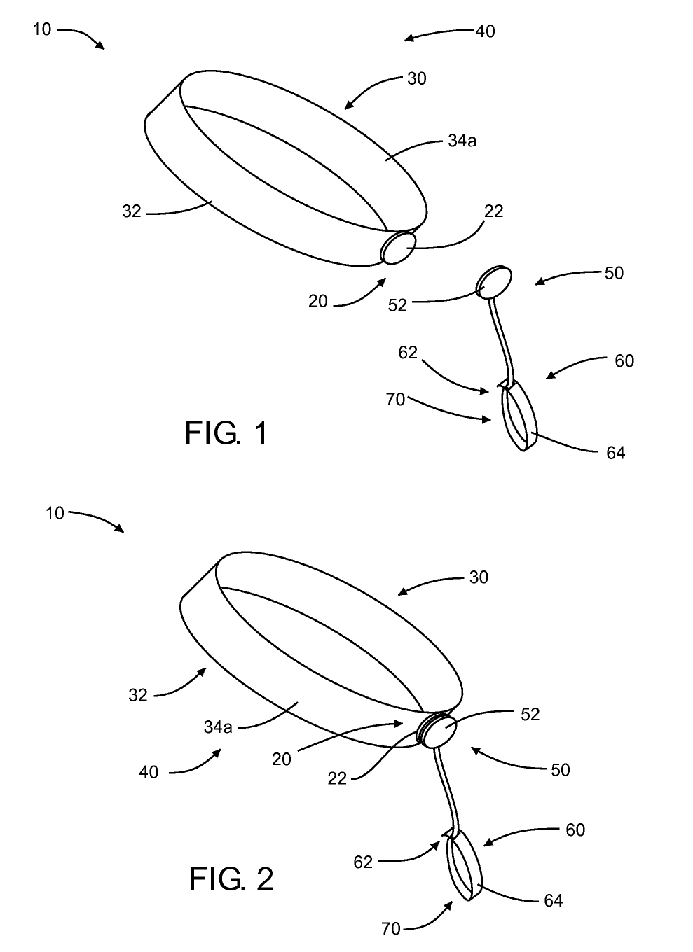

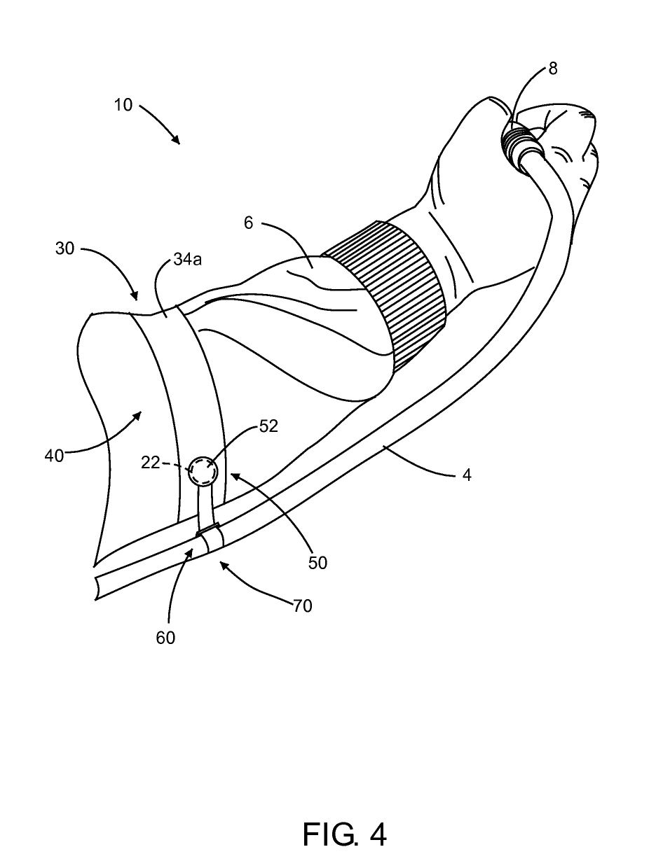

As illustrated in FIGS. 1-4, a hand tool cord tethering device, indicated generally at 10, is shown in accordance with an embodiment of the present invention for tethering a utility cord 4 of a hand tool 8, or handheld tool, to an arm 6 of user of the hand tool device. The tethering device 10 can include an arm coupler, shown generally at 20, and a cord coupler, shown generally at 50. The arm coupler 20 and the cord coupler 50 can be removably coupled together, as shown in FIGS. 2 and 4, to retain the cord along the user's arm when the user is holding the hand tool.

The arm coupler 20 can include a coupling device 22 that can be coupled to a mating coupling device 52 on the cord coupler 50. In one embodiment, the coupling device 22 can be a magnet or a magnetically attractable material, as shown in FIGS. 1-4. Advantageously, a magnetic arm coupler and cord coupler can allow coupling of the arm coupler and cord coupler by simply moving the arm coupler and cord coupler into a magnetically attractable proximity to one another, thereby allowing engagement without requiring assistance from an additional hand of the user.

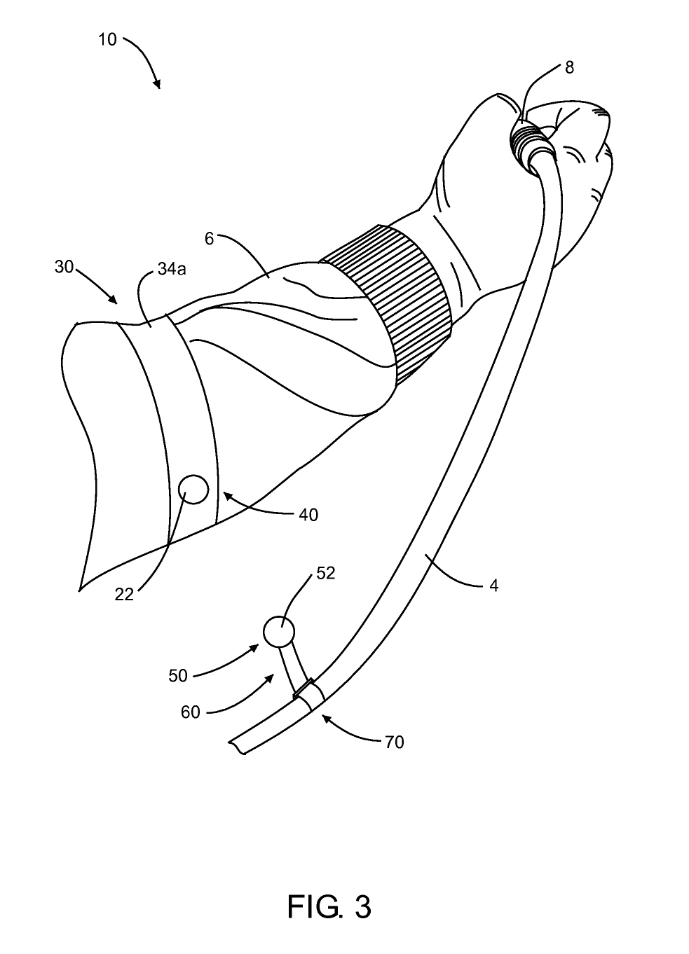

The arm coupler 20 can be attachable to the arm 6 of user of the hand tool 8. For example, the arm coupler can be disposed on an arm attachment portion, indicated generally at 30, that can be removably attachable to the arm of the user. The arm attachment portion 30 can include an attachment device, indicated generally at 32, for attaching the attachment portion to the arm 6 of the user. In one embodiment, the arm attachment device 32 can include a strap 34a, such as a flexible or elastic strap that can be stretched to fit around the user's arm, as shown in FIGS. 3-4. Advantageously, the strap 34a can be positioned on the user's arm so as to locate the arm coupler in a desired location that facilitates attaching the cord coupler to the arm coupler when the user holds the hand tool 8.

The arm attachment portion 30 can be configured to carry the coupling device 22. For example, as shown in FIGS. 1-4, the coupling device 22 can be attached to the attachment portion with an adhesive. Other fastening systems, such as hook and loop fastener systems, snaps, rivets, tape, and the like, can also be used to attach the coupling device to the attachment portion.

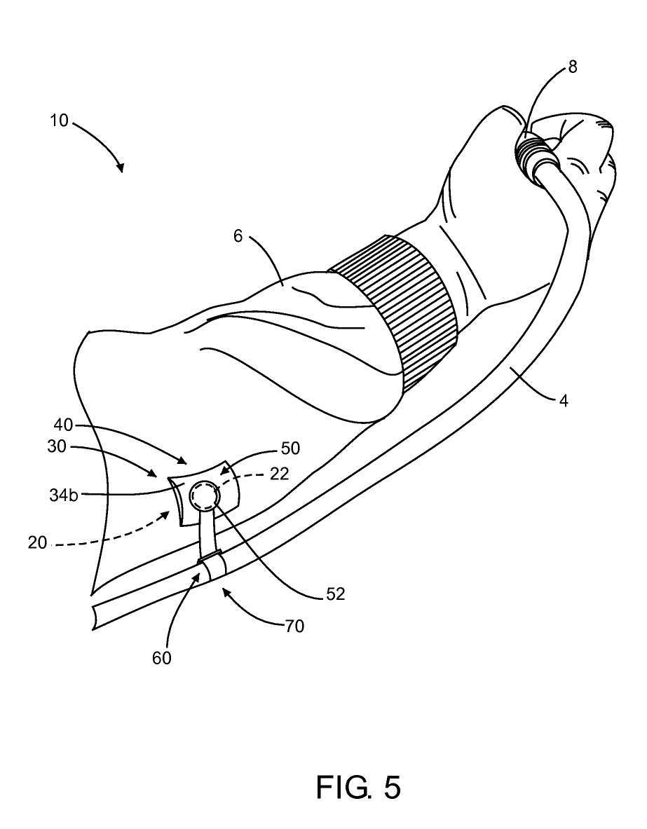

It will be appreciated that the arm attachment portion 30 can use other attachment devices to attach the arm coupler 20 to the user's arm 6. For example, the attachment device can be a pocket 34b on a sleeve 2, as seen in FIG. 5, and the arm coupler 20 can be disposed inside the pocket. In this case, the cord coupler 50 can be magnetically attracted to the arm coupler through the material of the pocket in order to attach the cord 4 to the arm 6 of the user. Additionally, although not shown in FIGS. 1-5, the attachment device can include a tie-able strap, a hook and loop fastener system, an adhesive, tape, and other similar devices as known in the art. Together the arm coupler 20 and the arm attachment portion 30 can form an arm piece, indicated generally at 40. Thus, working together as the arm piece, the arm coupler can be removably attached to the user's arm by attaching the arm attachment portion to the user's arm.

Although the embodiments described herein show an arm piece 40, it will be appreciated that the attachment portion can also attach to different parts of the user. For example, the attachment portion can be sized and shaped to attach and tether cords to the torso, the shoulder, the legs, or upper arm of the user.

Additionally, the attachment portion can be adjustable to fit users of various sizes as well as to fit over clothing or under clothing. For example, the arm attachment portion 30 can be adjustable in size so as to able to be worn next to the skin directly on the arm of the user with the sleeve of the user's shirt covering the arm attachment portion, or the arm attachment portion can be sized to be worn on top of the sleeve, as shown in FIGS. 1-4.

Also shown in FIGS. 1-4, the cord coupler 50 can be coupleable to a cord 4, cable, or line of the hand tool 8. For example, the cord coupler can be disposed on a cord attachment portion, indicated generally at 60, that can be removably attachable to the cord.

For simplicity, and not by way of limitation, the words cord(s), cable(s), and line(s) are used interchangeably herein. It will be appreciated that hand tools can have a variety of utility cords, cables, or lines attached to the hand tool to facilitate use of the hand tool. For example, dental hand tools can have pneumatic lines, suction lines, water lines, and the like. Other hand tools, such as minigrinders and vibropeeners can have power lines such as pneumatic, hydraulic, or electric lines. Accordingly, some hand tools may have more than one cord while others may only have a single cord. In either case, the concepts of the embodiments presented herein can be used to tether a single line or a plurality of cords. Hence, the cord coupler 50 can be coupled to a cord of the hand tool which may be a pneumatic line, a hydraulic line, an electric line, a suction line, a water or fluid line, a compressed air line, and a plurality or combination of such lines.

The cord attachment portion 60 can include an attachment device, indicated generally at 62, for attaching the cord attachment portion to the cord of the hand tool. In one embodiment, the cord attachment device 62 can include a strap 64, such as a flexible rubber or elastic strap that can be stretched to fit around the hand tool cord, as shown in FIGS. 3-4.

Advantageously, the strap 64 can be positioned on the cord 4 so as to provide sufficient slack in the cord to minimize drag or pull on the hand tool 8 from the cord. It will be appreciated that minimizing the drag of the cord on the hand tool can help the user maintain control of the hand tool which is especially helpful in high precision operations such as commonly encountered in dental settings. Reducing the drag of the cord also relieve stress on the user's hand and arm, thereby reducing possible fatigue the user may feel after prolonged use of the hand tool.

The length of the strap 64 can be varied such that the tethering effect of the attachment device 62 can be adjustable. In one aspect the strap can be adjustable in length from the cord coupler touching the armband directly all the way up to a desired length of tether, say for example four to six inches. In this way, the user can adjust the strap length to set the length of the tether to a comfortable or workable distance between the user's arm and the cord of the hand tool.

Additionally, the strap 64 can be sizable so as to be able to hold one or more cords, lines, cables, or the like. Moreover, in one aspect the strap can be cylindrically shaped so as to wrap around and hold the cords. In another aspect the strap can be pliable such that the strap can hold a plurality of cords and conform to the shape the plurality of cords regardless of the cords sizes or combined cross sectional shape.

The cord coupler 50 can include a mating coupling device 52 that can be coupled to the coupling device 22 on the arm coupler 20. In one embodiment, the mating coupling device 52 of the cord coupler can be one of a magnet or a magnetically attractable material, as shown in FIGS. 1-4. In this case, the coupling device 22 on the arm coupler 20 can be the other of a magnet or magnetically attractable material such that the coupling device of the arm coupler and the mating coupling device of the cord coupler can be magnetically coupleable together.

The attachment portion 60 can be configured to carry the cord coupling device 52. For example, as shown in FIGS. 1-4, the cord coupling device 52 can be attached to the attachment portion 60 with an adhesive. Other fastening systems, such as hook and loop fastener systems, snaps, tape, and the like, can also be used to attach the coupling device to the attachment portion.

It will be appreciated that other attachment devices can also be used to attach the cord coupler 50 to the cord 4 of the hand tool 6. For example, the cord attachment device 62 can be a strap, a cable tie, a hook and loop fastener system, an adhesive, tape, and other similar devices as known in the art.

Together the cord coupler 50 and the cord attachment portion 60 can form a cord piece, indicated generally at 70. Thus, working together as the cord piece, the cord coupler can be removably attached to the cord 4 of the hand tool 8 by attaching the cord attachment portion to the cord.

It will be appreciated that the embodiments of the hand tool cord tethering device described herein can be formed of materials that are easily reusable or disposable. In the case of reusable tethering devices, the materials can be of sufficient durability to withstand sterilizing processes, such as metallic or cloth based materials. In the case of disposable tethering devices, the materials can be inexpensive, such as plastic or urethane based materials

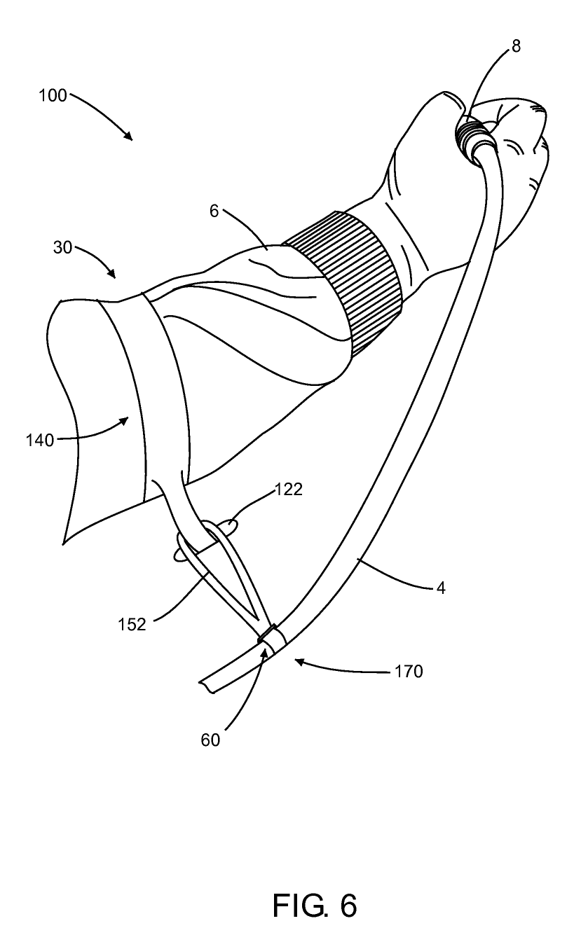

As illustrated in FIG. 6, a hand tool cord tethering device, indicated generally at 100, is shown in accordance with another embodiment of the present invention for tethering a utility cord 4 of a hand tool 8, or handheld tool, to an arm 6 of user of the hand tool device. The tethering device 100 can be similar in many respects to the tethering device 10 described above and shown in FIGS. 1-4. The tethering device 100 can include an arm piece, shown generally at 140, and a cord piece, shown generally at 170.

The arm piece 140 can include an arm attachment portion 30 and an arm coupler 120. The cord piece 170 can include a cord attachment portion 60 and a cord coupler 150. In this case, the arm coupler can be one of a toggle 122 and a loop 152, and the cord coupler can be the other of the toggle and the loop. It will be appreciated that the toggle and loop can be associated with either the arm coupler or the cord coupler even though FIG. 6 shows the toggle 172 associated with the arm coupler and the loop associated with the cord coupler.

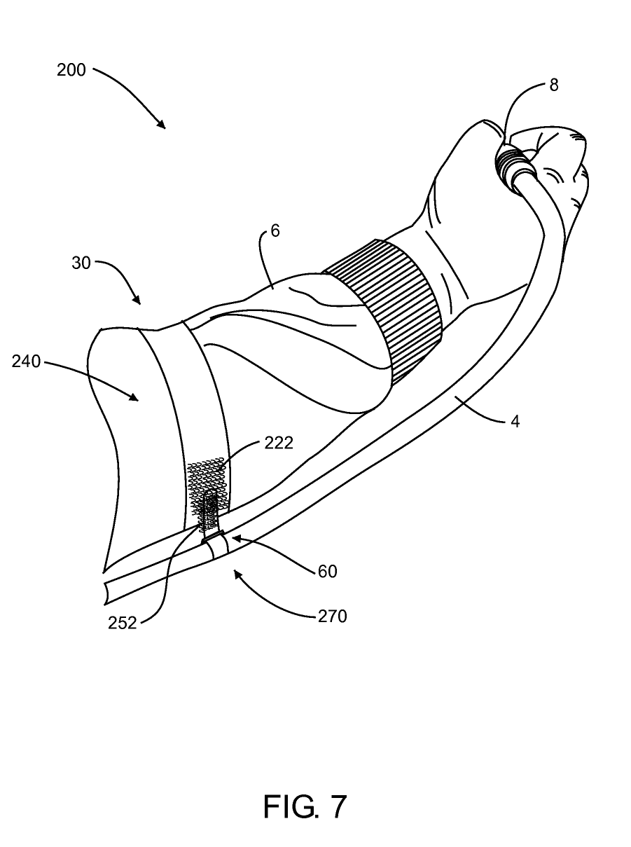

As illustrated in FIG. 7, a hand tool cord tethering device, indicated generally at 200, is shown in accordance with another embodiment of the present invention for tethering a utility cord 4 of a hand tool 8, or handheld tool, to an arm 6 of user of the hand tool device. The tethering device 200 can be similar in many respects to the tethering devices 10 and 100 described above and shown in FIGS. 1-6. The tethering device 200 can include an arm piece, shown generally at 240, and a cord piece, shown generally at 270.

The arm piece 240 can include an arm attachment portion 30 and an arm coupler 220. The cord piece 270 can include a cord attachment portion 60 and a cord coupler 250. In this case, the arm coupler can be a loop side 222 of a hook and loop fastener system such as Velcro®, and the cord coupler can be the hook side 252 of the hook and loop fastener system. It will be appreciated that the loop side and the hook side of the hook and loop fastener system can be associated with either the arm coupler or the cord coupler even though FIG. 7 shows the loop side associated with the arm coupler and the hook side associated with the cord coupler.

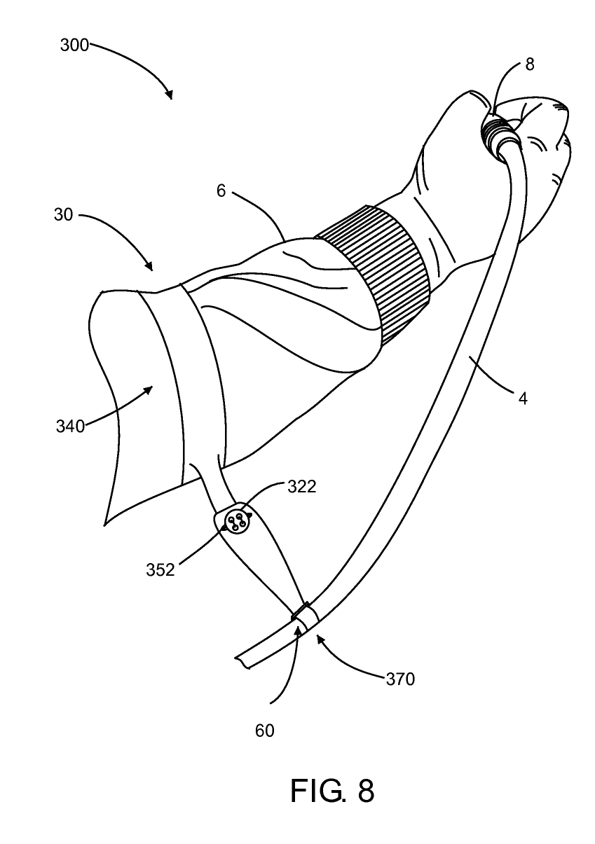

As illustrated in FIG. 8, a hand tool cord tethering device, indicated generally at 300, is shown in accordance with another embodiment of the present invention for tethering a utility cord 4 of a hand tool 8, or handheld tool, to an arm 6 of user of the hand tool device. The tethering device 300 can be similar in many respects to the tethering devices 10, 100, and 200 described above and shown in FIGS. 1-7. The tethering device 300 can include an arm piece, shown generally at 340, and a cord piece, shown generally at 370.

The arm piece 340 can include an arm attachment portion 30 and an arm coupler 320. The cord piece 370 can include a cord attachment portion 60 and a cord coupler 350. In this case, the arm coupler can be one of a button 322 and a buttonhole 352, and the cord coupler can be the other of the button and the buttonhole. It will be appreciated that the button and buttonhole can be associated with either the arm coupler or the cord coupler even though FIG. 8 shows the button associated with the arm coupler and the buttonhole associated with the cord coupler.

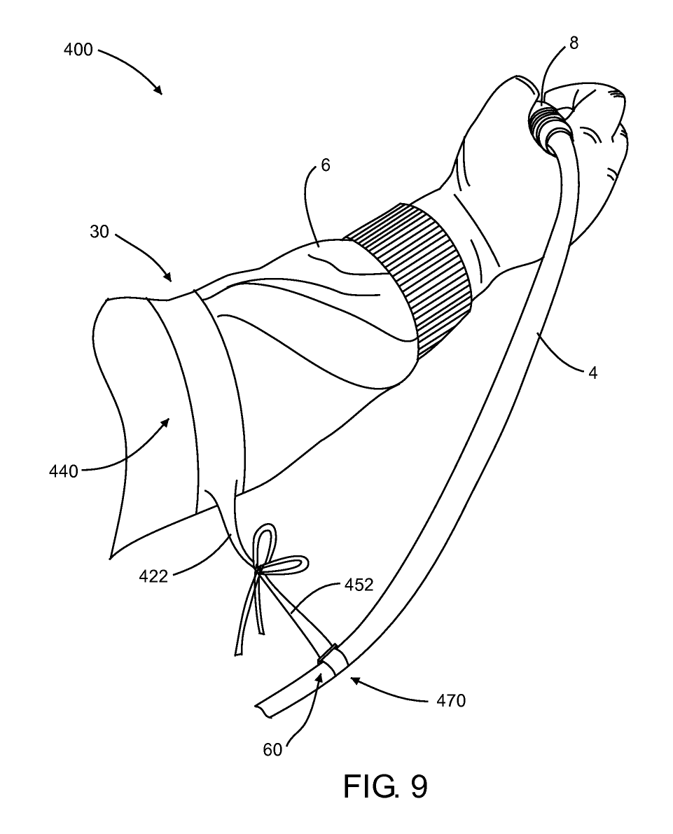

As illustrated in FIG. 9, a hand tool cord tethering device, indicated generally at 400, is shown in accordance with another embodiment of the present invention for tethering a utility cord 4 of a hand tool 8, or handheld tool, to an arm 6 of user of the hand tool device. The tethering device 400 can be similar in many respects to the tethering devices 10, 100, 200, and 300 described above and shown in FIGS. 1-8. The tethering device 400 can include an arm piece, shown generally at 440, and a cord piece, shown generally at 470.

The arm piece 440 can include an arm attachment portion 30 and an arm coupler 420. The cord piece 470 can include a cord attachment portion 60 and a cord coupler 450. In this case, the arm coupler can be one side 422 of a tie-able strap and the cord coupler can be the other side 452 of the tie-able strap.

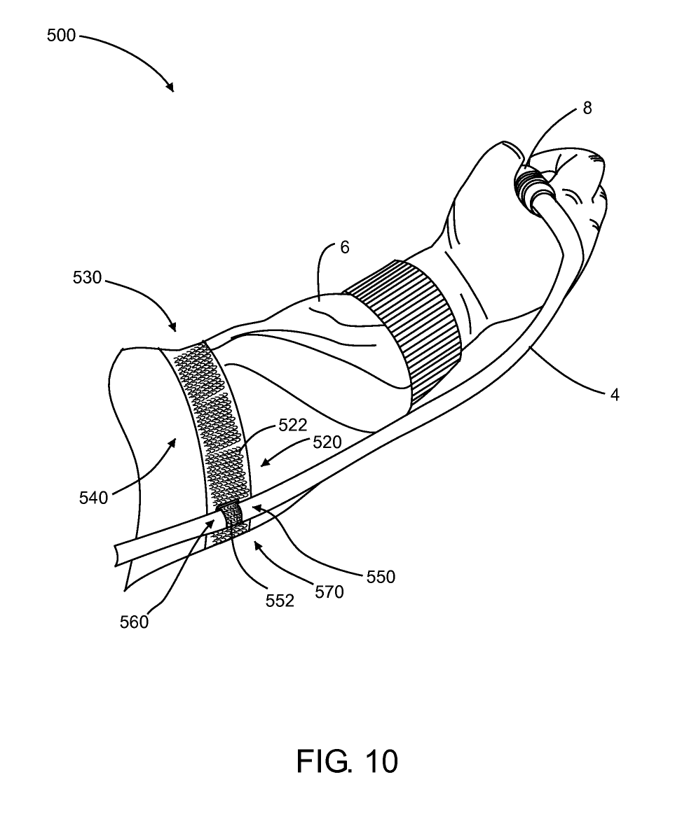

As illustrated in FIG. 10, a hand tool cord tethering device, indicated generally at 500, is shown in accordance with another embodiment of the present invention for tethering a utility cord 4 of a hand tool 8, or handheld tool, to an arm 6 of user of the hand tool device. The tethering device 500 can be similar in many respects to the tethering devices 10, 100, 200, 300, and 400 described above and shown in FIGS. 1-9. The tethering device 500 can include an arm piece, shown generally at 540, and a cord piece, shown generally at 570.

The arm piece 540 can include an arm attachment portion 530 and an arm coupler 520. The cord piece 570 can include a cord attachment portion 560 and a cord coupler 550. The cord coupler can be attached directly to the cord attachment portion so as to minimize or even eliminate the tethering distance between the arm of the user and the cord. For example, in this embodiment the arm attachment portion can include either hook 522 or loop fastener and the cord attachment portion can include the other of the hook or loop 552 fastener such that the cord attachment portion can attach directly to the arm attachment portion.

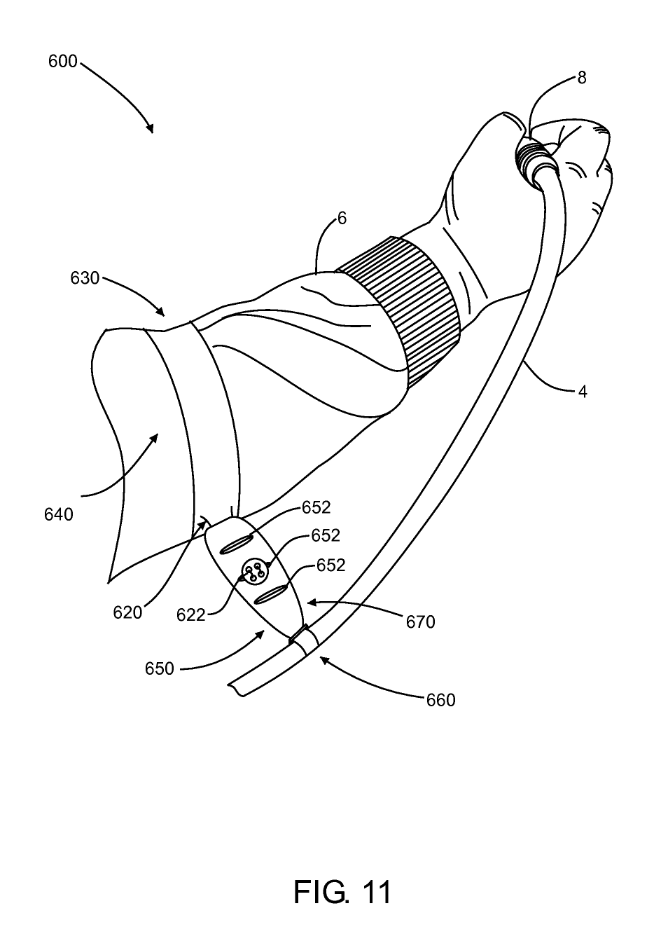

As illustrated in FIG. 11, a hand tool cord tethering device, indicated generally at 600, is shown in accordance with another embodiment of the present invention for tethering a utility cord 4 of a hand tool 8, or handheld tool, to an arm 6 of user of the hand tool device. The tethering device 600 can be similar in many respects to the tethering devices 10, 100, 200, 300, 400, and 500 described above and shown in FIGS. 1-10. The tethering device 600 can include an arm piece, shown generally at 640, and a cord piece, shown generally at 670.

The arm piece 640 can include an arm attachment portion 630 and an arm coupler 620. The cord piece 670 can include a cord attachment portion 660 and a cord coupler 650. The arm coupler and the cord coupler can be adjustable in length so as to be able to adjust the length of the tether between the user's arm 6 and the cord of the hand tool 8. For example, the arm coupler can include a button 622 and the cord coupler can include a plurality of button holes 652 spaced apart along a length of the cord coupler. In this case, the button of the arm coupler can be placed in one of the button holes of the cord coupler or moved to another hole if desired by the user. In this way, the user can adjust the strap length of the arm coupler and the strap length of the cord coupler in order to set the length of the tether to a comfortable or workable distance between the user's arm and the cord of the hand tool.

It will be appreciated that other coupling devices known in the art can also be used to couple the arm coupler and the cord coupler together.

The present invention also provides for a method for using a hand tool including tethering a cord of the hand tool to an arm of a user of the hand tool in order to reduce drag or pull of the cord of the hand tool on the user. The hand tool can be operated with the cord tethered to the user's arm.

The method can include coupling a cord coupler attached to the cord to an arm coupler attached to the user's arm so as to tether the cord to the user's arm.

The method can also include attaching a cord coupler to the cord of the hand tool and attaching an arm coupler to the arm of the user. The cord coupler can be coupled to the arm coupler with a coupling device so as to tether the cord to the user's arm.

In one aspect, the method the step of coupling the cord coupler to the arm coupler can include coupling a magnet in one of the cord coupler and the arm coupler to a magnetically attractive material in the other of the cord coupler and the arm coupler.

In another aspect, the step of attaching the cord coupler can include attaching a strap of the cord coupler to the cord. Similarly, the step of attaching the arm coupler can include attaching an arm band to the arm of the user.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A hand tool cord tether device, comprising:
a) an arm piece having an arm attachment portion disposable on an arm of a user of the hand tool and an arm coupler; and
b) a cord piece having a cord attachment portion disposable on a cord of the hand tool and a cord coupler removably attachable to the arm coupler on the arm piece so as to retain the cord along the user's arm when the user is holding the hand tool.

2. A device in accordance with claim 1, wherein the hand tool cord includes a cord selected from the group consisting of an electrical cord, a pneumatic line, a hydraulic line, a suction line, a water line, and combinations thereof.

3. A device in accordance with claim 1, wherein the arm attachment portion includes an attaching device disposable on the arm of the user selected from the group consisting of a strap, an elastic strap, a tie-able strap, a pocket on a sleeve, a hook and loop fastener, an adhesive, and combinations thereof.

4. A device in accordance with claim 1, wherein the arm coupler of the arm piece is selected from the group consisting of a magnet, a magnetically attractable material, a toggle, a loop, a hook and loop fastener system, a strap, a button and buttonhole fastener system, a snap fastener system, and combinations thereof.

5. A device in accordance with claim 1, wherein the cord attachment portion includes a cord attaching device disposable on the cord of the hand tool selected from the group consisting of a strap, an elastic strap, a sizable strap, a hook and loop fastener, an adhesive, a cable tie, and combinations thereof.

6. A device in accordance with claim 1, wherein the cord coupler is selected from the group consisting of a magnet, a magnetically attractable material, a toggle, a loop, a hook and loop fastener system, a strap, a button and buttonhole fastener system, a snap fastener system, and combinations thereof.

7. A device in accordance with claim 1, further comprising:
a) an arm band coupleable to the user's arm and carrying one of a magnet and magnetically attractable material; and
b) a strap coupleable to the cord and carrying the other of the magnet and magnetically attractable material.

8. A hand tool cord tether device, comprising:
a) an arm coupler attachable to an arm of a user of the hand tool;
b) a cord coupler attachable to a cord of the hand tool; and
c) the arm coupler being removably coupleable to the cord coupler to retain the cord along the user's arm when the user is holding the hand tool.

9. A device in accordance with claim 8 further comprising:
a) an arm attachment portion associated with the arm coupler and attachable to an arm of a user of the hand tool and configured to hold the arm coupler; and
b) a cord attachment portion associated with the cord coupler and attachable to a cord of the hand tool and configured to hold the cord coupler.

10. A device in accordance with claim 9, wherein the arm attachment portion includes an attachment device for attaching the arm coupler to the arm of the user selected from the group consisting of a strap, a pocket on a sleeve, a hook and loop fastener, an adhesive, and combinations thereof.

11. A device in accordance with claim 9, wherein the cord attachment portion includes an attachment device for attaching the attachment portion to the cord of the hand tool selected from the group consisting of a strap, a hook and loop fastener, and adhesive, a cable tie, and combinations thereof.

12. A device in accordance with claim 8, wherein the arm coupler includes a coupling device selected from the group consisting of a magnet, a magnetically attractable material, a toggle, a loop, a hook and loop fastener system, a strap, a button and buttonhole fastener system, a snap fastener system, and combinations thereof

13. A device in accordance with claim 8, wherein the cord coupler includes a coupling device selected from the group consisting of a magnet, a magnetically attractable material, a toggle, a loop, a hook and loop fastener system, a strap, a button and buttonhole fastener system, a snap fastener system, and combinations thereof

14. A device in accordance with claim 8, wherein the hand tool cord includes a cord selected from the group consisting of an electrical cord, a pneumatic line, a hydraulic line, a suction line, a water line, and combinations thereof.

15. A method for using a hand tool, comprising:
a) tethering a cord of the hand tool to an arm of a user of the hand tool; and
b) operating the hand tool with the cord tethered to the user's arm.

16. A method in accordance with claim 15, further comprising:
a) coupling a cord coupler attached to the cord to an arm coupler attached to the user's arm so as to tether the cord to the user's arm.

17. A method in accordance with claim 15, further comprising:
a) attaching a cord coupler to the cord of the hand tool;
b) attaching an arm coupler to the arm of the user; and
c) coupling the cord coupler to the arm coupler so as to tether the cord to the user's arm.

18. A method in accordance with claim 17, wherein the step of coupling the cord coupler to the arm coupler further comprises:
a) coupling a magnet in one of the cord coupler and the arm coupler to a magnetically attractive material in the other of the cord coupler and the arm coupler.

19. A method in accordance with claim 17, wherein the step of attaching the cord coupler includes attaching a strap of the cord coupler to the cord.

20. A method in accordance with claim 17, wherein the step of attaching the arm coupler includes attaching an arm band to the arm of the user.
